(19) United States
(12) Patent Application Publication
(10) Pub. No.: US 2010/0058652 A1
(43) Pub. Date: Mar. 11, 2010

(54) Method for Obtaining Fuels from Vegetal and Animal Fat Waste and Installation for Carrying out Said Method

(76) Inventors: Stefan Farwick, Munster (DE); Ludger Overmann, Lunen (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/161,861

(22) PCT Filed: Oct. 2, 2006
(86) PCT No.: PCT/EP06/09544

§ 371 Date: Jun. 9, 2009

(30) Foreign Application Priority Data
Jan. 23, 2006 (DE) 10 2006 003 328.0
Apr. 28, 2006 (DE) 10 2006 019 763.1

(51) Int. Cl. C10L 1/19; C10L 1/02; C11C 3/04; C11B 3/02

(52) U.S. Cl. 44/388; 422/206; 422/198

(57) ABSTRACT

The present disclosure relates to a method for obtaining fuels from vegetable and/or animal fat waste which contain, in addition to fat and/or oils, free fatty acids. The free fatty acids contained in the fat waste are reacted at reaction temperatures of above 220° C. with at least one polyvalent alcohol in the absence of enzymatic and solid neutral catalysts so as to produce the esterification of the free fatty acids.

### CROSS REFERENCES TO RELATED APPLICATIONS

This application is a National Stage filing of International Application PCT/EP2006/009544, filed Oct. 2, 2006, claiming the benefit of German Patent Application No. 10 2006 003 328.0, filed Jan. 23, 2006 and also to German Patent Application No. 10 2006 019 763.1, filed Apr. 28, 2006, both entitled “METHOD FOR OBTAINING FUELS FROM VEGETAL AND ANIMAL FAT WASTE AND INSTALLATION FOR CARRYING OUT SAID METHOD”. The subject application claims the benefit of PCT/EP2006/009544 and of German Application Nos. 10 2006 003 328.0 and 10 2006 019 763.1, all of which are expressly incorporated by reference herein, in their entirety.

### BACKGROUND OF THE INVENTION

The present disclosure relates to a process for obtaining fuels from vegetable-fat-based and animal-fat-based fat wastes, and also to the fuels produced therefrom and to the use thereof.

In addition, the present disclosure equally relates to a plant for carrying out the process according to the invention.

Fats and oils is the collective name for solid, semisolid or liquid, more or less viscose, products of the vegetable or animal body which consist chemically essentially of glycerol esters of higher fatty acids. Fats and oils are therefore triglycerides, that is to say ester compounds of glycerol with various fatty acids, in particular higher fatty acids. Generally, those fatty acids are termed higher fatty acids which contain more than twelve carbon atoms in the molecule. In the conventional triglycerides, one molecule of glycerol binds three molecules of fatty acid. The fatty acids contained in each triglyceride vary greatly and are species-dependent. In vegetable oils and fats, the fraction of unsaturated and polyunsaturated fatty acids predominates, where these can be, for example, oleic acid or linoleic acid, whereas saturated fatty acids, chiefly palmitic acid, only play a subsidiary role. In contrast thereto, in animals fats, the predominant fraction is monounsaturated fatty acids, principally oleic acid, and saturated fatty acids, principally palmitic acid and stearic acid, from which there results the high melting point of animal fats compared with vegetable fats and oils. For further details on fats and oils reference can be made, for example, to Römpp Lexikon Chemie [Römpp's, Chemistry Lexicon], 10th edition, volume 2, 1997, Georg Thieme Verlag Stuttgart/New York, pages 1320 to 1322, keyword: “Fette and Öle” [Fats and Oils].

In principle, fats and oils are renewable biogenic energy stocks and are therefore suitable as fuels. The expression fuels, according to the invention, is taken to mean, in particular, a summarizing description for solid, liquid or gaseous substances which, either in natural form or a form derived therefrom by refining, can be burnt economically with atmospheric oxygen with the release of utilizable heat (cf. Römpp Lexikon Chemie [loc. cit.] volume 1, 1996, pages 513/514, keyword: “Brennstoffe” [Fuels]).

Consequently, fats and oils can be used as fuels, for example for operating internal combustion engines. However, many accompanying substances of the fats and oils are undesirable for industrial utilization: pure fats and oils are odorless and taste-neutral; during storage for a relatively long time, however, under exposure to light and/or air, they become rancid, as a result of autoxidation and desmolysis, enzymatic or oxidative breakdown to give bad-smelling, short ketones and aldehydes. In addition, decomposition processes with elimination of glycerol occur, in which mono- and diglycerides and especially free fatty acids are formed. Predominantly in animal fats, in addition, as a result of the dietary intake, heavy metals are also present in very low concentrations, which can catalytically promote further decomposition of the fats and oils. The abovementioned unwanted accompanying substances of fats and oils, in particular free fatty acids, are found particularly in fat wastes of vegetable or animal origin.

When fats and/or oils are burnt and used as fuels for energy sources, although the abovementioned breakdown and decomposition products are burnt in conjunction, they have a disadvantageous effect on the exhaust gas composition and, in particular, act corrosively in relation to internal combustion engines. In particular, a high fatty acid content leads to a high corrosive wear of internal combustion engines.

Consequently, vegetable and animal fats and/or oils, in particular in the form of fat wastes, must be appropriately treated before their use in internal combustion engines.

A multiplicity of processes exist for treating fats for engine processes, in particular for burning them in internal combustion engines. Although the mucilages which are present as breakdown products and any heavy metals which are present can be removed by washing with aqueous acidic solutions, the corrosive free fatty acids are not removed by this means; these must rather be removed by washing with alkaline solution, for example sodium hydroxide solution, with such processes being uneconomic and thus unprofitable as a result of the high consumption of alkaline treatment agent.

In order to reduce the acidity of fats and oils, in addition there is the possibility for separating off the fatty acids by steaming distillation (Lurgi) or by selective extractants (for example isopropanol/hexane or basic extractants, cf., e.g. DE 199 18 097 A1).

DE 199 56 599 A1 describes a process for producing deacidified fats and oils, wherein technical triglycerides having acid values of up to 60 are treated with lower aliphatic alcohols in the presence of lipases, in such a manner that a preesterification product having an acid value in the range from 0.5 to 10 results, and the reaction product, after removal of water and unreacted alcohol, and subsequent drying, is subjected to a reesterification, with repeated addition of lower aliphatic alcohols, in the course of which reesterification the acid value of the starting materials is reduced to values in the range from 0.1 to 0.5. This process is complex, since a second esterification, preesterification and reesterification, must be carried out which is uneconomic on a large industrial scale. In addition, the process demands the use of enzymatic catalysts in the form of lipases, which have the disadvantage that, in the event of relatively long storage of the deacidified fats and/or oils under industrial conditions, they lead to an unwanted breakdown and/or to an unwanted decomposition of the fats and oils.

In addition, DE 101 55 241 C1 describes a process for producing fuels from acidic vegetable or animal fats having a content of free fatty acids by catalytic esterification reaction in a tower apparatus, wherein the free fatty acids contained in the acidic fats are esterified at elevated temperature and under vacuum with polyhydric alcohols in the presence of solid neutral metal catalysts which are present within the reaction system in a fixed bed, wherein the acidic fats are conducted in the reaction system from top to bottom and in this respect in countercurrent to the alcohol, and under the action of the vacuum, a mixture containing alcohol and water is taken off in the upper part of the reaction system. The process described there is associated with a number of disadvantages: firstly, the process described there obligatorily requires the use of metal catalyst; although this metal catalyst is present in a fixed bed, certain amounts of the metal catalyst are constantly co-discharged into the treated fats which obligatorily must be removed by acidic washing before combustion of the treated fats. In addition, the catalytic activity is rapidly exhausted because of the formation of mucilages as reaction byproducts which are deposited onto the catalyst surface, such that these must be frequently regenerated or exchanged. In addition, the process described in DE 101 55 241 C1 requires a complex tower apparatus and a complex process procedure, since the acidic fat, on the one hand, and the esterification alcohol, on the other hand, must be conducted in countercurrent.

The object of the present disclosure is therefore to provide a process and a corresponding plant, with which process, or with which plant, fuels can be obtained starting from vegetable and/or animal fat wastes which contain, in addition to fats and/or oils, free fatty acids, and/or with which process or with which plant free fatty acids can be removed or reacted from vegetable and/or animal fats and/or oils, in particular fat wastes.

The applicant has now surprisingly found that, in the case of acidic fats and oils, in particular in the case of vegetable and/or animal fat wastes which contain free fatty acids, the free fatty acids can be reacted with polyhydric alcohols to give the corresponding esters, even in the absence of enzymatic and solid neutral catalysts, in particular in the absence of metal catalysts, in an esterification reaction, provided that reaction temperatures above 220° C. are selected.

To achieve the object described above, the present disclosure therefore proposes a process and a plant as disclosed and claimed hereinafter. Further advantageous embodiments of the process according to the present disclosure and of the plant according to the present disclosure are disclosed herein.

The present invention—according to a first aspect of the present disclosure—therefore relates to a process for obtaining fuels starting from vegetable and/or animal fat wastes which, in addition to fats and/or oils, contain free fatty acids, whereby the free fatty acids contained in the fat wastes are reacted at reaction temperatures T_{reaction} above 220° C. (T_{reaction}>220° C.) with at least one polyhydric alcohol in the absence of enzymatic and solid neutral catalysts in such a manner that esterification of the free fatty acids proceeds.

A crucial feature of the process according to the present disclosure is considered to be that the reaction temperature is selected to be above 220° C. (T_{reaction}>220° C., wherein the lower limit of 220° C. is not included), since under these conditions an at least essentially complete reaction of the free fatty acids or an at least essentially complete esterification of the free fatty acids to the corresponding esters proceeds, and this succeeds without the relevant catalysts and without significant decomposition or denaturing of the fats and oils thus treated occurring.

In principle, any fat wastes of vegetable and/or animal origin can be used in accordance with the process according to the present disclosure. In this case the expression fat wastes is used according to the invention, for simplicity, as a collective name for wastes based on fats and/or oils. These include, for example, wastes based on animal fats, old fats, cover fats, industrial residue fats, fats from oil separators, fats from sewage treatment plants, fats from tanneries and acidic vegetable fats and oils.

For example, waste fats based on farm animal fats, in particular pig fat, beef tallow, mutton tallow, horse fat or goose and chicken fat, but also based on acidic fish oils can be used.

The acidic fats and oils used according to the present disclosure can be, for example, fat wastes not requiring special monitoring for utilization by food-processing enterprises which are obliged by the German Wasserhaushaltsgesetz (WHG) [Water Management Act] to connect a low-density material cutoff before introduction of the wastewater, or other animal and vegetable fats and oils having a high content of free fatty acids.

Preferably, fat wastes having a content of free fatty acids of 5 to 80% by weight, in particular from 10 to 75% by weight, preferably 25 to 75% by weight, based on the fat wastes are used. This corresponds to fat wastes having acid values approximately in the range from 10 to 160, in particular 20 to 150, preferably 50 to 150, wherein the acid value (AV) gives the number of mg of KOH which is required to neutralize 1 g of the respective sample or fat wastes and is used for determining the content of free organic acids in fats and oils (cf. Römpp Lexikon Chemie, loc. cit., volume 5, 1998, page 3903, keyword: “Säurezahl” [acid value] and the DIN standard 53169: 1991-03 and 53402: 1990-09 referred to there).

In a manner preferred according to the present disclosure, use is made of fat wastes having a content of free fatty acids of 25% by weight, based on the fat wastes. This corresponds to fat wastes having acid values of approximately at least 50. In principle, fat wastes having a lower content of free fatty acids can also be used; however, in the event that the free fatty acid content is below 25% by weight, based on the fat wastes, it is advisable to add a basic starter catalyst, in particular in the form of an inorganic hydroxide, but this measure is optional and is less preferred according to the invention.

Since, as mentioned above, a particular advantage of the process according to the present disclosure is considered to be in particular that the reaction is carried out in the absence of enzymatic and solid neutral catalysts. In particular, no metal catalysts are used which have to be injected into the fat wastes to be treated and subsequently removed. Generally, the process according to the present disclosure succeeds without any catalyst, i.e. it is carried out in the absence of a catalyst.

Surprisingly, the process according to the present disclosure, despite the omission of a catalyst, leads to an at least essentially complete reaction of the free fatty acids contained in the fat wastes to give the corresponding fatty acid esters.

It is equally surprising that the relatively high reaction temperatures do not adversely affect the quality of the neutralized fats and/or oils ultimately obtained, in particular do not lead to thermal decomposition products to a significant extent.

In the context of the process according to the present disclosure, the polyhydric alcohol is an at least dihydric alcohol, in particular an at least trihydric alcohol, preferably a dihydric to tetrahydric alcohol. Particularly preferably, the polyhydric alcohol is selected from the group of diols such as ethylene glycol, triols such as glycerol, pentaerythritol and pentitols, in particular from the group of ethylene glycol and/or glycerol. Mixtures of different polyhydric alcohols can also come into consideration according to the invention.

In a manner preferred according to the present disclosure, the polyhydric alcohol is glycerol. This is linked to a plurality of advantages: firstly, the glycerol, as a trihydric alcohol, can bind a larger amount of fatty acids and thus delivers an expedient mass balance. Secondly, glycerol has the particular advantage that the fatty acids are predominantly converted into triglycerides which are chemically equal to the major mass of the fat wastes to be treated. In addition to the triglycerides, however, mono- and diglycerides are also formed, so that generally a mixture of different glycerol esters, in particular of mono-, di- and triglycerides is formed, wherein generally the triglycerides form the main component.

Glycerol has additionally the advantage that in technical form it is available relatively inexpensively. Although technical glycerol has a relatively high water fraction, this can be removed before the reaction without problem, for example by evaporation or drawing off the water from the mixture to be reacted before the reaction. However, attention should be paid to the fact that, in the case of the use of technical glycerol, this is essentially free of methanol and/or ethanol, in order to prevent competing esterification reactions with methanol and/or ethanol of the free fatty acids which are to be reacted.

Generally, the reaction of the free fatty acids is carried out with an excess of polyhydric alcohol, based on the free fatty acids contained in the fat wastes. In particular, the process is carried out with an excess of 5 to 40% by weight, preferably 10 to 30% by weight, particularly preferably 15 to 20% by weight, of the polyhydric alcohol in relation to the free fatty acids contained in the fat wastes. The figure of the excess of the polyhydric alcohol relates to the mass of the polyhydric alcohol used in total. For this purpose it is advantageous to determine the content of free fatty acids in the fat wastes to be treated before reaction in order to be able to determine the excess to be used. For reasons of process economics, excess unreacted polyhydric alcohol can be separated off again and recovered after reaction and subsequently recycled. Separating off the excess polyhydric alcohol, in particular glycerol, after the reaction is relatively problem-free, since after the reaction mixture is cooled a two-phase mixture results—the polyhydric alcohol, in particular the glycerol, is immiscible with the fats and oils—so that the unreacted polyhydric alcohol may be readily separated off. The excess unreacted polyhydric alcohol separated off in this manner can then be fed back to the next reaction batch.

As described above, the reaction or esterification reaction proceeds generally at reaction temperatures T_{reaction} in the range from above 220° C. (lower limit not included) to 270° C., in particular 225° C. to 265° C., preferably 225° C. to 250° C., particularly preferably 230° C. to 240° C. Attention should be paid to the fact that the reaction is carried out at temperatures which are below the boiling point of the polyhydric alcohol used.

Generally, the reaction is carried out in a stirred reactor which is equipped with the corresponding stiffing devices for mixing the reaction mixture. It has proved to be particularly advantageous when the stirred reactor, in addition to the stiffing devices, has at least one nozzle for atomization, i.e. for atomization or fine distribution, of the reaction mixture, wherein, using the nozzle, the reaction mixture is continuously sprayed during the reaction, in particular atomized and/or finely distributed. As a result, the reaction may be accelerated. Without wishing to be bound to a defined theory, the reaction accelerated in this manner may be explained by an enlargement of the reaction surface area. For example, the nozzle can be arranged in such a manner that it is immersed in the reaction mixture, wherein via a line situated at the lower part of the stirred reactor, a part of the reaction mixture is continuously taken off and fed to the nozzle head which is immersed in the reaction mixture, for purposes of spraying. In other words, the reaction mixture, during the reaction, is mixed by stirring with the corresponding stiffing devices or stirring tools and preferably, in addition, is sprayed, i.e. atomized or finely distributed by a nozzle which is additionally present (“esterification nozzle”).

Generally, the reaction is carried out discontinuously, i.e. chargewise or batchwise.

For completion and/or acceleration of the reaction, it is advantageous when the reaction water which is formed in the reaction is taken off continuously. This proceeds by means of continuous evaporation or withdrawal of reaction water formed, since operations are carried out at temperatures above the boiling point of water. Advantageously, for this purpose, a slight reduced pressure is applied, in particular in the range from 100 to 300 mbar, in particular 150 to 250 mbar.

Generally, the reaction is carried out overall at atmospheric pressure or at reduced pressure, in particular at a reduced pressure in the range from 100 to 300 mbar, in particular 150 to 250 mbar.

Generally, the reaction proceeds in such a manner, in particular over such a time period, that the reaction of the fatty acids to the corresponding esters proceeds to at least 95%, in particular to at least 97%, preferably to at least 98%, very particularly preferably to at least 99% (degree of conversion).

In this case the reaction generally proceeds in such a manner, in particular over such a time period, that the content of free fatty acids after the reaction is at most 2% by weight, in particular at most 1% by weight, preferably at most 0.5% by weight, particularly preferably at most 0.1% by weight, very particularly preferably at most 0.05% by weight, based on the product mixture (i.e. the neutralized fats and/or oils) obtained after the reaction. The reaction mixture obtained after the reaction generally has an acid value of at most 4, in particular at most 2, preferably at most 1, particularly preferably at most 0.2, very particularly preferably at most 0.1.

The reaction as such is generally carried out for a time period of 0.1 to 5 hours, in particular 0.5 to 4 hours, preferably 0.75 to 1.5 hours.

The fat wastes to be neutralized or transesterified are generally, still before the actual reaction with the polyhydric alcohol, subjected to a physical treatment. The physical treatment comprises, in particular, a (physical) separation of water contained in the fat wastes, for example by means of decanting, wherein, in particular, a residual water content 0.5% by weight, based on the fat wastes, is set. Equally, the physical treatment comprises a mechanical separation of solids, preferably by means of sieving and/or filtration, wherein the fat wastes are set to residual solid contents 0.1% by weight, based on the fat wastes. In the context of the physical treatment upstream of the actual reaction, the fat wastes are therefore firstly freed from excess water and secondly solids and sediments. The fat wastes treated in this manner can then, if appropriate,—before their subsequent reaction with the polyhydric alcohol—be stored temporarily in a buffer tank until a sufficient amount for the subsequent reaction has collected in the buffer tank.

After completion of the reaction, the reaction products, if appropriate after cooling, can be subjected to a physical aftertreatment (post-treatment). The aftertreatment (post-treatment) comprises generally a physical separation of solids which are formed in the reaction products in the reaction, in particular mucilages, as can be formed, in particular, by denaturation of the fats and oils; the solids, in particular mucilages, are separated off preferably by means of filtration (“polishing filtration”), in particular using filter aids (e.g. cellulose, silica gel, kieselguhr, perlites, charcoal or wood dust). In addition, the aftertreatment (post-treatment) comprises separation of the excess unreacted polyhydric alcohols which are present in the reaction products, in particular by means of phase separation (the polyhydric alcohols are generally immiscible with the product mixture of fats and/or oils); as described above, excess unreacted polyhydric alcohol is subsequently advantageously recycled.

The reaction products obtained after the process according to the present disclosure (i.e. the neutralized polished fat and/or oil mixtures which are freed from fatty acids) can, if appropriate, after intermediate storage in a buffer tank, subsequently be fed as fuels to a heat engine, in particular an internal combustion engine. There, they can serve for the propulsion of vehicles of any types, for example ships, or else in power stations for obtaining power.

The process according to the present disclosure therefore enables efficient production of neutralized fat and/or oil mixtures starting from acidic fatty acid-containing starting fat mixtures and/or oil mixtures, in particular fat wastes, and therefore of biogenic fuels. The process according to the present disclosure surprisingly succeeds without catalysts, so that it firstly operates inexpensively and in a less complex manner in the process procedure than processes which operate with catalysts, and secondly the risk of carry-over of catalysts into the end products is excluded.

Particularly good results are obtained when, as starting raw materials, use is made of acidic fat and/or oil mixtures or fat wastes having a content of free fatty acids of at least 25% by weight, or having acid values of at least 50, and/or when the process is carried out using an excess of the polyhydric alcohol in relation to the free fatty acids, since in this case the reaction proceeds in a particularly short time and at particularly good degrees of conversion.

The present disclosure further relates to, according to a second aspect of the present disclosure, the neutralized fats and/or oils as such which are obtainable from acidic (i.e. starting from free-fatty-acid-containing) vegetable and/or animal fat wastes, or fuels based on vegetable and/or animals fats. The neutralized fats and/or oils or fuels which are obtainable by the process according to the invention are distinguished by a low content of free fatty acids of at most 2% by weight, in particular at most 1% by weight, preferably at most 0.5% by weight, particularly preferably at most 0.1% by weight, very particularly preferably at most 0.05% by weight based on the neutralized fats and/or oils or fuels, which approximately corresponds to acid values of at most 4, in particular at most 2, preferably at most 1, particularly preferably at most 0.2, very particularly preferably at most 0.1. The products which are obtainable by the process according to the disclosure comprise, when glycerol is used as polyhydric alcohol, generally a mixture of mono-, di- and triglyceride fats and/or oils (i.e. a mixture of various glycerol esters), wherein the triglycerides generally form the main portion.

The present disclosure further relates - according to a third aspect of the present invention—to the use of the neutralized fats and/or oils or (biogenic) fuels obtainable by the process according to the present disclosure for operating a heat engine, in particular an internal combustion engine, or for operating a power station, or for power generation and/or heat generation.

Finally, the present disclosure further relates—according to a fourth aspect of the present disclosure—to a plant for carrying out the above described process according to the present disclosure, wherein the plant comprises the following units in the sequence of the process steps to be carried out and in each case connected in series:
a) a treatment unit 1 for the physical treatment of vegetable and/or animal fat wastes which, in addition to fats and/or oils, contain free fatty acids and a certain fraction of water and solids, (the treatment unit 1 can comprise, in particular, a device for the physical separation of water, in particular a decanting device, and/or a device for separating off solids, in particular a sieve and/or filter device);
b) in the production line downstream of the treatment unit 1, if appropriate, a buffer tank 2 for receiving and/or intermediate storage of the physically treated fat wastes originating from the treatment unit 1;
c) in the production line downstream of the treatment unit 1 and/or to the buffer tank 2 which is present if appropriate, a reactor unit 3 for carrying out an esterification reaction of the physically treated fat wastes fed from the treatment unit or the buffer tank, in particular in the form of a stirred reactor having stirrer tools for mixing the reaction mixture (the reaction unit 3 is constructed so as to be heatable via a heating medium 5 and esterification alcohol from a storage tank 4 and the physically treated fat wastes from the treatment unit 1 and/or the buffer tank 2 which is present, if appropriate, can be fed, preferably as separate feedstock streams, to the reactor unit 3);
d) in the production line downstream of the reactor unit 3, if appropriate an intermediate tank 7 for receiving and/or intermediate storage, in particular for cooling, of the crude product mixture originating from the reactor unit (the intermediate tank 7 can be coupled to a heating medium 8, in particular a heat exchanger, for removing heat and recirculating it to the reactor unit 3).

In addition, the plant according to the present disclosure can comprise
e) in the production line downstream of the reactor unit 3 and/or of the intermediate tank 7, which is present if appropriate, an aftertreatment (post-treatment) unit 9 for the physical aftertreatment (post-treatment) of the crude product mixture originating from the reactor unit 3 and/or the intermediate tank 7 which is present, if appropriate (the aftertreatment unit 9 can comprise in particular a device for the physical separation of solids, in particular of mucilages formed in the reaction, preferably a filtration device, and/or a device for the physical separation of water, in particular a decanter device and/or centrifuge device).

In addition, the plant according to the present disclosure, can comprise
f) in the production line downstream of the aftertreatment (post-treatment) unit 9, a tank 10 for receiving and/or intermediate storage of the aftertreated, in particular polished, product mixture originating from the aftertreatment unit 9 (the tank 10 at its lower part, in particular at the foot of the tank 10, can in particular comprise a line for taking off unreacted esterification alcohol which settles at the foot of the tank 10 and for its recirculation to the storage tank 4).

The various units, tanks, vessels and the like 1, 2, 3, 4, 7, 9 which are series-connected in the production line are each advantageously connected to one another via lines. In this case the individual lines are preferably constructed so as to be able to be shut off separately from one another and/or to be able to be controlled separately from one another.

The reactor unit 3 of the plant according to the present disclosure can, in a particularly advantageous embodiment, additionally have a nozzle 6 for the atomization and/or fine distribution of the reaction mixture. In this case the nozzle 6 can be arranged in such a manner that, in the operating state of the reactor unit 3 it is immersed in the reaction mixture, wherein, via a line (“loop”) which is situated at the lower part of the reactor unit 3, in particular at the foot of the reactor unit 3, reaction mixture can be taken off and fed into the nozzle 6.

According to an embodiment preferred according to the present disclosure, the plant according to the present disclosure is integrated into a power station, in particular into a block-type thermal power station (BHKW), or is a component thereof. In this embodiment, downstream of the plant according to the present disclosure, at least one heat engine, in particular at least one internal combustion engine, can be connected downstream for power and/or heat generation by combustion of the fat wastes treated in the plant according to the present disclosure.

For further details of the plant according to the present disclosure, reference can be made to the respective details on the process according to the present disclosure which apply, mutatis mutandis, with respect to the plant according to the invention.

Further advantages, features, properties and aspects of the present disclosure result from the description hereinafter of a preferred embodiment with reference to the sole drawing.

### BRIEF SUMMARY

One object of the present disclosure is to describe an improved method for obtaining fuels from vegetable and/or animal fat waste which contain, in addition to fat and/or oils, free fatty acids. The free fatty acids contained in the fat waste are reacted at reaction temperatures of above 220° C. with at least one polyvalent alcohol in the absence of enzymatic and solid neutral catalysts so as to produce the esterification of the free fatty acids.

### BRIEF DESCRIPTION OF THE SEVERAL VIEWS OF THE DRAWINGS

FIG. 1 shows a diagrammatic simplified sequence of the process according to the invention and a diagrammatic simplified structure of a plant according to the invention.

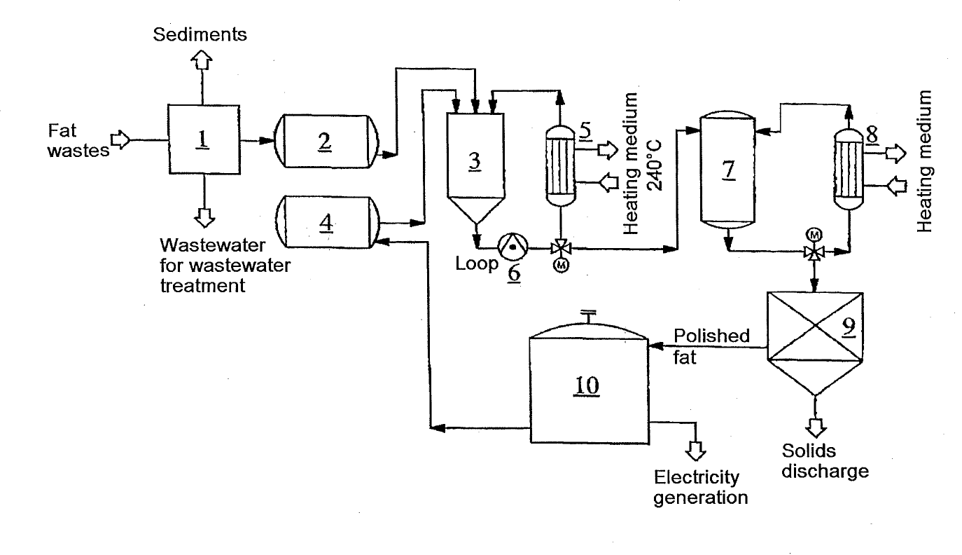

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

At 1 physical treatment of the raw material (fat wastes) of fats/oils, water and sediments proceeds. The fat wastes to be treated can be, for example, wastes not requiring special monitoring for utilization from food-processing enterprises which are obliged by the German Water Management Act (Wasserhaushaltsgesetz, WHG), to provide a light material separator upstream before the introduction of the water, or wastes based on animal and vegetable fats having a high content of free fatty acids, as described above. These fatty acids make it impossible to date to convert these fats and oils to electrical power, for example in a block-type thermal power station (BHKW), since the high to very high contents of free fatty acids are highly corrosive and would destroy not only burners but also engines in a short time.

In the mechanical and physical treatment 1, from the raw materials or fat wastes delivered, therefore firstly water and secondly sediments are removed. The residual water content in this case is advantageously set to values below 0.5% by weight, based on the raw materials, and the residual solid content or residual sediment content to values <0.1% by weight at a grain size cut of 50 μm, in each case based on the raw materials. These are optional initial conditions for the downstream chemical treatment or reaction.

The fat wastes freed in the physical treatment 1 from water and solids or sediments can if appropriate be stored temporarily in a buffer tank 2, from where they then can be fed to the chemical treatment plant or the reactor 3, together with polyhydric alcohol originating from the storage tank 4, preferably glycerol, for esterification of their free fatty acids. In the chemical treatment plant (reactor) 3, the free fatty acids contained in the raw fats and oils, generally having fatty acid contents above 25% by weight, based on the fat wastes, in the absence of enzymatic and solid neutral catalysts, are reacted with the alcohol or glycerol in stoichiometric excess in the manner according to the invention at temperatures above 220° C., in particular converted into the corresponding glycerol esters, predominantly triglycerides, wherein mono- and diglycerides are formed as byproducts. The advantage of the reduction or removal of the content of free fatty acids taking place in this manner is that even raw materials having large amounts of free fatty acids can be treated without loss of mass—in contrast to processes of the prior art which remove the free fatty acids by alkaline scrubbing. The reactor 3 is brought to the corresponding reaction temperature via a corresponding heating medium 5. According to a particular embodiment, in the reactor 3, in addition to stirring devices, at least one nozzle (“esterification nozzle”) 6 is present for spraying, in particular atomization or fine distribution, of the reaction mixture, wherein the reaction mixture which is fed to the nozzle 6 and is to be sprayed, is taken off via a line or line loop in the lower part of the reactor 3, in particular at the foot of the reactor 3.

After the esterification reaction has ended, the product is fed to a tank 7 for the purposes of cooling, wherein the heat given off on cooling can be fed back to the esterification via a heating medium or a heat exchanger 8. The cooled product is freed from mucilages by means of polishing filtration in 9, generally using filter aids (e.g. perlites), wherein the resultant press cake can be stored temporarily, for example in a water-tight vessel until proper disposal. The product which is purified in this manner, i.e. the neutralized and polished fats and/or oils, can then be transported, e.g. via a double-walled heated piping system, into fuel tanks 10 and from there fed to commercially conventional engines which are suitable for heavy oil for power generation.

Further embodiments, modifications and variations of the present invention can be recognized and achieved without problem by a person skilled in the art on reading the description without leaving the context of the present invention.

The invention will now be described in more detail with reference to an exemplary embodiment which, however, is in no way restricting with respect to the present invention.

Exemplary embodiment:

The process according to the present disclosure corresponding to the schematic drawing in the sole figure will be employed in the present exemplary embodiment in the context of operating a block-type thermal power station (BHKW):

The plant according to the present disclosure described hereinafter is a block-type thermal power station having a fired heat output less than 20 MW in which biogenic fuels based on treated animal and/or vegetable fats are used for power and heat generation in accordance with the German Act on promotion of renewable energies (EEG) or the biomass regulation (BiomasseV).

Pumpable acidic fat wastes, in particular fat separator contents, which on average contain 20% by weight acidic fats and/or oils, 75% by weight water and 5% by weight sediments, are received, for example, from closed suction trucks in a closed system. After connection of a pressure-tight line to the suction truck this actively forces the pumpable fat separator contents at a nominal pressure of at most 1 bar into a manifold, and after the manifold, separation of coarse matter proceeds in a sieve having a mesh width of 10 mm, wherein the sieve pressure is monitored; any blockage of the sieve is indicated both by differential pressure monitoring and also by falling flow rates in the flow monitoring. The coarse sieve is manually cleaned on a workday basis, the coarse matter separated off is supplied to a supervised utilization. The storage of the coarse matter separated off proceeds in tightly closed lidded containers.

Downstream of the coarse sieve, the fat separator contents are passed into a balancing or vacuum vessel, in which the level is monitored. From there the crude material is homogenized by means of a screw pump and passed into a tank garden where the delivered fat separator contents are stored temporarily until processing. The tank garden consists of two standing tanks having a utilizable volume each of 400 m³, wherein both tanks, using a heating circuit of the power station, are heated to a temperature of 35° C. The tanks are charged alternately via the receiving region. The heating and continuous mixing of the tank contents proceeds using a heat exchanger. The crude material is drained off from the tank at the bottom, passed via a heat exchanger and passed back into the tank at the top.

The heated fat/water mixture is subsequently transported from the tank via a heated piping system into the physical treatment. The physical treatment consists of a three-phase decanter and a separator. The fats are transported directly into the decanter from the tank garden via the heated pipe system. The fat/water mixture is heated via the heating circuit of the BHKW to a temperature of 80° C. The water released in the decanter is fed to the wastewater treatment, sediments separated off are discharged by a compression screw and stored temporarily in a water-tight container until proper disposal. The fat obtained is further heated to a temperature of 95° C. via the heating circuit of the power station and purified in the separator. The water phase released here is again fed to the wastewater treatment, sediments are stored temporarily in a water-tight container until proper disposal. The containers for storage of the sediments are provided with active venting, wherein the exhaust air is purified via a corresponding biofilter in order to avoid possible odor emissions.

The fat obtained in the physical treatment is stored temporarily in a buffer tank having a volume of 50 m³ until further treatment in the chemical treatment.

The chemical treatment of the fats proceeds batchwise. This produces 60 t of fuel (mixture of mono-, di- and triglycerides and glycerol ester mixture) in 4 batches (charges) per 24 hours. The fats are transported from the buffer tank of the physical treatment via a piping system into the reactor and heated using the high-temperature circuit of the power station to a temperature above 220° C., in particular to about 230° C. to about 245° C. With addition of technical glycerol from a storage tank, the free fatty acids which are contained in the fat wastes are reesterified in the absence of catalysts.

The reesterification proceeds at atmospheric pressure in a time period of about one and a half hours. The reactor is a stirred reactor having stiffing tools for mixing the reaction mixture and one or more additional esterification nozzles, immersed in the reaction mixture, for spraying the reaction mixture.

After batch operation is ended, the product is freed from mucilages, in the context of a polishing filtration using filter aids, by means of a chamber filter press. The press cake is stored temporarily in a water-tight container until proper disposal. The purified product is transported into the fuel tanks via a double-walled heated pipe system.

Downstream of the treatment, the fuel obtained which is based on the resultant fat and/or oil mixture freed from free fatty acids is stored temporarily until combustion. The fuel store consists—just as does the tank garden—of two tanks having a volume each of 400 m³. The tanks are constructed having a single wall and are equipped with a vacuum bottom, a level controller and a leak indicator. In addition, they are safeguarded by a raised edge as collision protection.

The internal combustion engines of the BHKW are operated exclusively with the fuel obtained as described above. This fuel has the property of crystallizing out at temperatures below 30° C. In normal operation of the power station, therefore, the fuel store and the fuel lines are heated by means of a heating circuit of the power station in order to maintain the optimum viscosity of the fuel. If the power station is shut down, it must be ensured that no fuel remains in the lines and machines and hardens there. For this reason, conventional diesel is used as fuel for start-up and shut-down of the power station.

The internal combustion engines of the power station are two diesel engines each of 3.257 MW installed electrical power. The engines are 9 cylinder/4-stroke in-line engines with supercharging and supercharging air cooling. They are originally designed for ship propulsion and are now equipped for operation with the biofuel produced according to the invention. Each engine is coupled to an alternating current synchronous generator. The electrical energy generated is fed into a 10 kV power supply grid via a 10 kV switching system.

Downstream of each motor-generator unit is connected an NOₓ-reduction unit for purifying the resultant flue gases.

In the exhaust gas vessel, the hot combustion gases of the diesel engines are utilized in order to heat a thermal oil to 250° C. for what is termed the high-temperature circuit.

The power station is designed for generating power in long term operation. During the operating time, the chemical energy of the charged fuels is converted into heat energy by combustion. The two engines deliver a thermal power of 8.6 MW. The heat energy is fed via the hot exhaust gases to the exhaust gas vessel. The majority of the heat is, as described above, received by a thermal oil as carrier medium.

The wastewater produced during the fuel treatment is purified in a water treatment plant which comprises a fat separator, a reservoir tank and a flotation unit. The water treatment plant effects a residual separation of emulsified hydrocarbons and heavy metals after a pretreatment by a separator unit. By means of the recleaning of the wastewaters, maintenance of the threshold values with respect to pH, hydrocarbons, lipophilic substances and heavy metals, is ensured. COD and BOD values are decreased to a high extent.

While the preferred embodiment of the invention has been illustrated and described in the drawings and foregoing description, the same is to be considered as illustrative and not restrictive in character, it being understood that all changes and modifications that come within the spirit of the invention are desired to be protected.

1-30. (canceled)

31. A process for obtaining fuels starting from vegetable and/or animal fat wastes, said fat wastes comprising, in addition to fats and/or oils, free fatty acids,
wherein said process comprises reacting the free fatty acids contained in the fat wastes, at a reaction temperature T_{reaction} above 220° C., with at least one polyhydric alcohol in the absence of enzymatic and solid neutral catalysts such that esterification of the free fatty acids is performed.

32. The process as claimed in claim 31, wherein fat wastes having a content of free fatty acids of 5 to 80% by weight, based on the fat wastes, are used.

33. The process as claimed in claim 31, wherein the polyhydric alcohol is an at least dihydric alcohol.

34. The process as claimed in claim 31, wherein the reaction is carried out with an excess of polyhydric alcohol of from 5 to 40% by weight, based on the polyhydric alcohol in relation to the free fatty acids contained in the fat wastes.

35. The process as claimed in claim 31, wherein the reaction is carried out at reaction temperatures T_{reaction} in the range of from above 220° C. to 270° C. and at atmospheric pressure or at reduced pressure for a time period of from 0.1 to 5 hours.

36. The process as claimed in claim 31, wherein the reaction is carried out in a stirred reactor, wherein the stirred reactor, additionally to stirring devices, has at least one nozzle for atomization or fine distribution of the reaction mixture, by means of which during the reaction the reaction mixture is continuously atomized or finely distributed.

37. A fuel based on vegetable and/or animal fats, said fuel being obtained by a process as claimed in claim 31, wherein said fuel comprises a content of free fatty acids of at most 2% by weight, based on the fuel, and has an acid value of at most 4.

38. A plant for carrying out a process for producing fuels starting from vegetable and/or animal fat wastes which, in addition to fats and/or oils, contain free fatty acids, wherein the plant comprises the following units in the sequence of the process steps to be carried out and in each case connected in series:
a) a treatment unit for the physical treatment of vegetable and/or animal fat wastes which, in addition to fats and/or oils, contain free fatty acids and a certain fraction of water and solids, wherein the treatment unit comprises a device for the physical separation of water and a device for separating off solids;
b) in the production line downstream of the treatment unit, optionally a buffer tank for receiving and intermediate storage of the physically treated fat wastes originating from the treatment unit;
c) in the production line downstream of the treatment unit and/or the optional buffer tank, a reactor unit for carrying out an esterification reaction of the physically treated fat wastes fed from the treatment unit or the buffer tank in the form of a stirred reactor having stirrer tools for mixing the reaction mixture, wherein the reactor unit is constructed so as to be heatable via a heating medium and esterification alcohol from a storage tank and the physically treated fat wastes from the treatment unit and/or the optional buffer tank are fed as separate feedstock streams, to the reactor unit;
d) in the production line downstream of the reactor unit, optionally an intermediate tank for receiving and intermediate storage of the crude product mixture originating from the reactor unit, wherein the intermediate tank is coupled to a heating medium on the basis of a heat-exchanger for removing heat and recirculating it to the reactor unit.

39. The plant as claimed in claim 38, wherein the plant further comprises:
e) in the production line downstream of the reactor unit and/or of the optional intermediate tank, a post-treatment unit for the physical post-treatment of the crude product mixture originating from the reactor unit and/or the optional intermediate tank; and
f) in the production line downstream of the post-treatment unit, a tank for receiving and intermediate storage of the post-treated product mixture originating from the post-treatment unit.
